(19) United States
(12) Patent Application Publication
(10) Pub. No.: US 2015/0194159 A1
(43) Pub. Date: Jul. 9, 2015

(54) Methods and Apparatuses for Removal of Steganograpy Message from Media Content

(71) Applicant: Anthony Mai, San Marcos, CA (US)

(72) Inventor: Anthony Mai, San Marcos, CA (US)

(73) Assignee: Anthony Mai, San Marcos, CA (US)

(21) Appl. No.: 14/225,414

(22) Filed: Mar. 25, 2014

Related U.S. Application Data
(60) Provisional application No. 61/924,398, filed on Jan. 7, 2014.

(51) Int. Cl. G10L 19/018; G10L 25/18; G06F 3/16

(52) U.S. Cl. CPC G10L 19/018; G06F 3/165; G10L 25/18; H04R 2420/01

(57) ABSTRACT

Methods and apparatuses to remove watermarks and other steganography messages embedded in media contents, and render the said hidden information un-detectable by its intended receivers.

### CROSS REFERENCE TO RELATED APPLICATIONS

Current application claims priority from U.S. Provisional Patent Application Ser. No. 61/924,398, entitled “Methods and Apparatuses for Removal of Hidden Information from Media Content”, filed on Jan. 7, 2014 by current inventor. That provisional application is hereon referred as The Provisional.

### FIELD OF INVENTION

The present invention relates to the field of intelligence, security and steganography. More specifically it relates to watermarks and other steganography messages embedded in media contents.

### BACKGROUND OF INVENTION

Steganography is the art of hiding information in ways that are unnoticeable by human. Such hidden information can be detected and retrieved by intended receivers using secret methods or apparatus. On the other hand, methods and apparatuses can be developed to remove such hidden information and render it un-detectable by intended receivers to thwart secret communication by steganography.

The following Definitions and Terms clarify the terms used in the description of current invention:

### Definitions and Terms

Audio: Any stored information content for immediate or later renditions into audible sound.

Picture: Any stored information content for immediate or later display into a visible image.

Video: Any stored information content for immediate or later renditions into a sequence of continuous moving pictures, for human users to see. A video is generally accompanied by related audio content to allow human users to see a scene while hearing the sound at the same time.

Document: Any stored information content for immediate or later rendition into sequences of human comprehensible symbols, texts, images, video and audio.

Media: Any audio, picture, video or document intended for human usage, as described above.

Storage medium: Any material or apparatus that contains information content of media as described. Media can be created through recording of the real world, or through fictitious construction. Examples of media creation through recording include photography and TV footages of news events. Examples of media creation through fiction include novel writing, computer animated cartoon or computer generated music, artificial human voice or computer animated motion pictures.

Analog technology: Prior to invention of digital computer and digital information technologies, the information content of media were stored in analogy form, and were later rendered using analogy devices and technology. For example music was stored on vinyl Long Play (LP) discs as gramophone records, and motion pictures were stored on motion picture films and played back in cinemas.

Digital technology: Since digital computers and digital information technologies were invented, audio and visual media is more commonly stored as digital information records, and rendered using apparatuses based on digital technology, like a computer, a digital TV set or a DVD player.

Hidden Information: Secret information deliberately incorporated into media content without being noticeable to human users. Such hidden information can be extracted and interpreted by methods and apparatuses that are known only to selected parties with possession of such methods and apparatuses.

Steganography: Art of hiding information in ways unnoticeable by human. Such hidden information can be identified and extracted using secret methods or apparatuses that are only available to intended receivers. Most commonly, steganography messages are embedded in media contents.

All media content is intended for rendition for human perception of images and sounds and texts. Typical media content contain more information than what can be perceived by human users. Such information redundancy provides opportunity to incorporate and embed secret information into media contents, in ways unnoticeable and unperceivable to human users, so as to accomplish the goal of using said media content to clandestinely deliver information to intended end receivers.

In steganography, secret rules and methods are invented to allow information senders to incorporate secret information into media contents. Such contents are delivered to the end receivers and recovered using secret rules and methods. Parties other than the senders and receivers are unaware of such secret rules and methods needed to extract the said secret information, and hence cannot extract the secret information. It is generally believed that a third party, in no possession of the knowledge needed to identify the secret information, is unlikely to be able to temper with the said secret information, and thus will deliver the secret information intact to the end receiver.

Many methods and apparatuses are invented for such information hiding in media contents. Some of such intentions are kept as trade secret while the others some are patented. Many such inventions are widely used by terrorists, criminals or spy agents to deliver secret information, or by media content publishers to incorporate secret copyright information, for the purpose of tracking content copying.

A third party unaware of the above discussed secret information delivery and with no knowledge of the secret rules or methods applied, may desire to thwart and frustrate such secret information deliver, by processing the media content in ways that does not impact human users, but yet renders such secret information undetectable to end receivers, thus the secret messages are blocked.

There exist some prior arts of removing steganography messages contained in media contents. US Patent 20110243327 describes a system and method to remove audio watermarks, by shifting audio frequency in a random fashion to prevent watermark detection, and then resample portion of the audio to restore its original time length. However such a method has the disadvantage of introducing audible distortion to the original audio, as human ears can identify shifted audio frequency easily, especially when such a frequency shift is altered randomly throughout the audio, instead of applied uniformly.

In 2003, Darko Kirovski et al published a research paper titled “Blind Pattern Matching Attack on Watermarking System”, which can be found at the web link below:
http://www.petitcolas.net/fabien/publications/tsp03-pattern-matching.pdf

In the paper, Darko Kirovski described a method of identifying perceptually similar elements of the media contents and then swapping them, in order to disrupt detection of the hidden watermark messages. However such a method is computationally intensive in identifying perceptual similarities in elements of media content, and it is not guaranteed that perceptually similar elements can always be found.

As media content watermarking methods can be used by terrorists, criminals and foreign spy agents to communicate secret messages undetected, with devastating consequences, a general method that can effectively prevent detection of watermark messages is not only novel and non-obvious, but also useful.

### SUMMARY OF INVENTION

The present invention provides methods and apparatuses for processing media contents to remove secret information and render the same undetectable by its intended end receiver, without possessing any knowledge as of how the secret information was embedded in or can be extracted from the media, and with no significant alteration to human perception of the said media content.

Since information hiding in media contents has not been widely practiced for a long history, there have been neither significant needs, nor serious efforts to develop counter measures to remove such hidden information from media contents. So the field of application is still novel.

Inventor of present invention is not aware of any prior art in the field of hidden information removal from media contents. Such prior arts, even if they exist, likely contain no similarity to current claims.

Human perceptions, including visual, audio, and reading perceptions, are not perfect. In general, human perceptions are insensitive to spatial and time variations that are either too abrupt, too short, or too long, or too gradually, or variations that are too small. Such insensitivities in human perceptions provide ample opportunity to alter media contents without significant alteration to human perception.

Specifically, media contents can be partitioned into small pieces spatially, or temporally. Subsequent to such partitioning, pieces that are in close proximity to each other, or pieces that are far apart but perceptually similar, can be exchanged. Certain pieces can be inserted or removed here and there. After such swapping, insertions and deletions, the pieces can then be reconstructed into new media content seamlessly, with virtually imperceptible difference from the original media content.

On the other hand, any information, when represented digitally, is represented by a sequence of bits of 1s and 0s. When information is hidden in media content, such secret sequence of bit 1s and bit 0s will be embedded in the media content in sequential order. The end receivers of such secret information must assume that they can extract such sequence of 1s and 0s from the media content sequentially, and they expect the embedding of such secret bits to be uniformly distributed spatially or temporally to facilitate easy identification and extraction, given the specifics of how these bits are embedded in the first place.

That fundamental characteristics of secret information being a sequence of secret bits 1s and 0s, and that such sequence is sequentially embedded in the media content spatially or temporally, cannot be kept as a secret, as it is logically obvious. This widely open non-secret characteristics of most watermarking or information hiding scheme, provides the opportunity to easily thwart detection of secret watermarks, without any knowledge of the specifics of how such watermark or secret information was embedded.

To put it simple, the media content scrambling as described previously, by ways of partitioning the media content into small pieces and then swapping, inserting and deleting them, also scrambles the sequence spatially and temporally. As the sequence is scrambled, even in the unlikely cases that the individual secret bits can still be extracted, they occur out of proper order to construct the original secret watermark package. Thus the original secret watermark information is rendered undetectable and lost.

Simply speaking, a correct bit found at an incorrect position is still an incorrect bit.

The essence of basic principles of the present invention has been described as above.

The present invention covers all media forms, including audio, picture, video and document.

The present invention covers both media created from recording and created from fictitious creation.

The present invention covers media stored and/or processed in all forms, analogy and digital.

The present invention covers media stored in all storage mediums, including but not limited to analog storages, like analog films and gramophone records; like computer hard drives, music CDs, DVDs, BluRay DVDs, various portable and non-portable electronic devices like iPhone and camcorders.

The present invention is much superior to any previous art of trying to thwart secret communication by steganography or encryption. It has profound implication to the entire field of watermark, information hiding and data security. Previous arts of attempting to thwart information hiding concentrate on efforts to destroy individual bits and fail to recognize the non-obvious fact that universally, all information is represented by bits, digits or symbols arranged in certain sequential order. When such sequential order can be disrupted, the bits and pieces no longer represent any meaningful information as they become mere noise. The present invention allows such sequential order to be disrupted while allows perception quality of media content to be preserved. As a result, most steganography methods based on information hiding in media content can be defeated by methods according to current claims.

### BRIEF DESCRIPTION OF DRAWINGS

FIG. 1 shows an example audio content with secret information embedded, prior to processing using methods according to current invention. The series of numbers above identify the original time sequence. The audio waveform is shown as waveform in the middle. The hidden bits of secret information are indicated below. The hidden bits represent ASCII code of the text “Secret code”:

### Binary:

0101001101100101011000110111001001100101011101000010000001100011011011110110010001100101 ASCII: 53 65 63 72 65 74 20 63 6F 64 65 Secret code

FIG. 2 shows the sample example audio content after processing using methods according to current invention, with secret information scrambled, after processing using methods provided by current invention. The audible perception of the audio is hardly distinguishable from the original audio. Yet the sequence of the hidden bits is scrambled to render the hidden message un-recognizable. The text of the ASCII code of the bits of the hidden information is now “′KfÒKh [symbol] oHÕ”, as:

### Binary:

0010011101001011011001101101001001001011011010001010000011000110011011110100100011010101 ASCII: 27 4B 66 D2 4B 68 A0 C6 6F 48 D5 ′KfÒKh [symbol] oHÕ

### DETAILED DESCRIPTION OF INVENTION

The present invention removes secretly embedded watermark or steganography messages from media content, without causing significant alternation of the human perception of said media content, by first partitioning the said media content into small slices and then manipulating the sequences of such slices before constructing them back into a new version of said media content.

Human perceptions of audio, video and readable contents have the inherent weakness that gradual variations, as well as abrupt but brief variations in media contents are imperceptible. Therefore, when media content is partitioned into small slices, and neighboring slices are re-arranged in order, or out of places slices that are similar in perception are swapped, such manipulation causes no alternation in their human perception, so long as the slices are small enough, and swapped slices are similar enough.

Nevertheless, such re-ordering and swapping of small slices alters the proper sequence of the hidden information, rendering the hidden information undetectable by intended receivers.

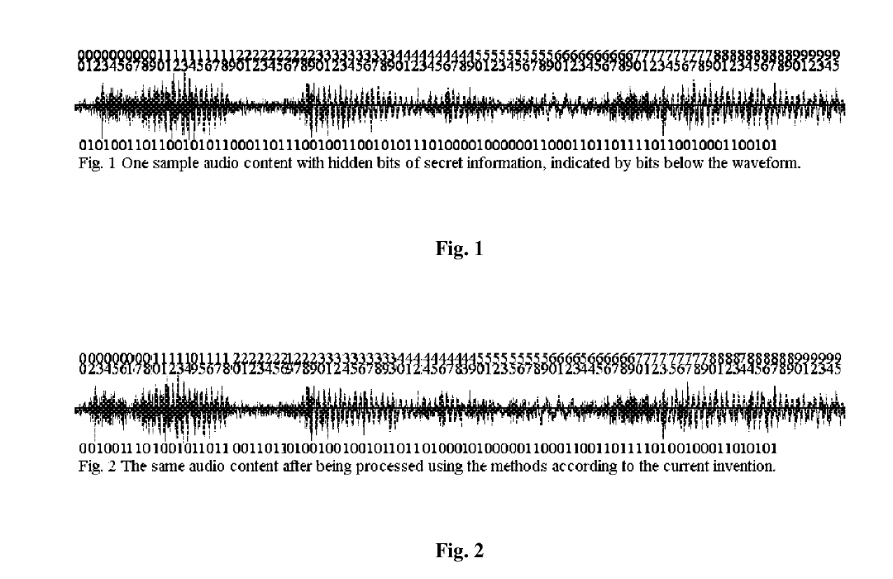

Referring now to the invention in more detail in FIG. 1, there is shown an example audio content with hidden information embedded. The audio waveform is shown in the middle. The series of numbers above identify the time sequence. The series of 0s and 1s below identify the hidden information bits. In the example audio the secret bits represent the ASCII code of the text “Secret code”.

For one embodiment example, hidden information in the sample audio in FIG. 1 can be removed by a method according to claim 1, in steps as described below:
1. The audio media is represented by sequential data samples taken at uniform time intervals depending on a sample rate per second, with each data sample being a value above or below 0.
2. The sequence of audio samples can be partitioned into many small segments in different ways.
3. The segments are then manipulated before being used to construct a new audio sequence.
4. Some segments are removed, some segments are duplicated, and some neighboring segments are swapped. And some similar segments that are not close to each other are swapped.
5. After such manipulation, segments are seamlessly connected into a full audio sequence. Each two neighboring segments are seamlessly connected by weighed calculation of sample values, with the sample values from first segment takes a weight gradually reduced from 100% to 0%, and the sample values from the second segment takes a weight going from 0% to 100%. The two are added to obtain the new sample value. This is calculated over a transition time gap.

After the above processing, the processed audio content is shown in FIG. 2 with the series of 0s and 1s at the bottom represent secret information bits that were scrambled. The secret bits in FIG. 1 decode to ASCII code of text “Secret code”. After processing, the secret bits in FIG. 2 decode to the ASCII code of text “′KfÒKh AEoHÕ”, which has no recognizable meaning to the intended receiver.

Media content can be either audible or visible. Information can be hidden in audio contents, or in visual contents. Visual contents include pictures, video, visible patterns or readable text. Referring to claim 10, hidden information in visual contents can be removed using methods based on the same principle as described herein. For another embodiment example, hidden information contained in a picture can be removed by a method according to claim 10, in steps as described below:
1. The picture is represented by a two dimensional array of pixel points. Each pixel point has a color value. A color value is represented by three color component values: red, green and blue. Each color component value is a value from 0 to a maximum value like 255.
2. The two dimensional array of pixels of the picture is partitioned into pixel blocks each of n by n pixels. The n is chosen to be a small number so that a human user will not be able to notice any significant difference of color in pixels within each block.
3. Neighboring pixel blocks, as well as pixel blocks not next to each other but look similar, are randomly swapped. Some pixel blocks are removed and replaced with replications of similar pixel blocks. This transformation is repeated throughout the entire image content.
4. After the transformation, common digital filtering techniques are applied to smooth out any artifacts introduced, so that the all the pixel blocks look like seamlessly connected.

After the above processing, the sequence of bits of any hidden information embedded in the picture is scrambled and thus will no longer be recognizable by an intended decoder of such secret information.

For further elaboration of the methods of current invention, we refer to audio content in FIG. 1 again. Referring to claim 1, there are several steps involved in the processing as described below:

Step 1A. The audio content to be processed may or may not contain secret information for removal. How such secret information is embedded in the audio content, is not within the scope of claims.

Step 1B. The audio is processed to convert to a format suitable for further processing. For example the audio sampling rate may need to be converted; compressed audio data may need to be processed to recover uncompressed raw audio data. The gain of audio may need to be amplified or reduced. Many prior arts provide methods of such pre-processing of audio content. It is intended that when such methods are utilized to process media contents for subsequent processing by methods according to claims of current invention, such said methods are within the scope of claims of current invention.

Step 1C. The audio content is partitioned into small slices. There can be a plural of methods to segregate or partition the audio, including but not limited to the following:
cutting the audio by uniform or non-uniform length of each segment according to claim 2;
copying segments of the audio at different offset positions according to claim 3;
or obtaining segments of audio at different offset positions and then using such segments to calculate specific audio characteristics parameters, using methods like Fast Fourier Transform, and then using such parameters to reconstruct small slices of audio, according to claim 4.

It is intended that any and all methods of partitioning any media content for subsequent processing using methods provided by current invention, are within the scope of claims of current invention.

Step 1D. Once the audio content is partitioned into small slices, these slices can be scrambled by a plural of methods that preserve the perception quality of the content. Different Slices can be identified as similar one by their proximity to each other, or by calculation of their characteristics parameters. Prior arts provide a plural of mathematical calculations to identify the similarities of media slices. It is intended that any and all methods of identifying similar media slices for subsequent scrambling and processing according to methods according to current claims, are within the scope of current claims.

Step 1E. Subsequent to scrambling, the audio slices are smoothly joined to form the output audio. Two slices can be joined by calculating a weighed average of data from them; with the data from first slice taking a weight gradually reducing from 100% to 0% while the data from second slice takes a gradually increasing weight from 0% to 100% according to claim 5 Prior arts provide a plural of other methods to smoothly join media slices. Any and all such methods to join media slices for processing in accordance to current claims, are intended to be within the scope of current claims.

Step 1F. Once a new audio content is constructed, it can be processed, converted and stored to be made useful for subsequent usage. Such processing, conversion, storage or delivery, as part of the processing in accordance of current claims, is intended to be within the scope of current claims.

Embodiments of the above steps can be varied in order to achieve better result of preserve perceptual quality of the media content while preventing the detection of embedded watermarks, but the basic principle of segregating original media contents into small slices, process these slices, and then merge them seamlessly to construct a new copy of the media content, remains the same. All such varied or improved embodiments are within the scope of current claims.

For example, in Step 1C, each slice of the audio does not need to be of uniform length. They can have varied length. Likewise, the slices do not have to be taken continuously from the original media content. They can have overlaps and gaps between them. Due to the alternation of overlaps and gaps, parts of the audio, when reconstructed into a continuous audio content, will be slightly shifted forward or backward in time. This causes the watermark detector to allocate the embedded watermark bits at wrong positions.

For one example, first slice can come from original audio sample 1 to sample 1800, with a length of 1800 samples; second slice comes from sample 1751 to 3500, with a length of 1750 samples, and the third slice comes from sample 3601 to sample 5600, with a length of 2000 samples. In this example, the three slices have different lengths of 1800, 1750, 2000 samples respectively; slice one and two overlap as they both use samples 1751 to 1800, while there is a gap of samples 3501 to 3600 that no slices use.

For another example, in order for slices to be joined smoothly in step 1E, the offset and size of each slice is carefully chosen, based on the characteristics of the media content. In step 1E, while the calculated weight gradually shifts from a previous slice to a next slice, the audio waveform changes nevertheless. To minimized perceptual artifacts introduced by such transition, the offset of the next slice can be so chosen that the overlapped part of the waveform looks similar, and the peaks are aligned, so that the transition will have a minimal impact to the waveform change.

In summary, media contents typically contain a huge amount of information. Human perceptions, however, can only perceive a small fraction of the information. Most media contents contain lots of repeated or similar elements. Human sensations perceive such repetitions and similarities as beauty.

Such beauty provides ample opportunities to replace and swap elements of repetition and similarity to disrupt methods of hiding information behind human perceptions.

Embodiments of methods provided by current invention can be modified and improved in many ways to remove hidden information by disrupting the sequence of similar parts of any media content. Any and all such embodiments are intended to be included within the scope of the claims declared herein.

### INDUSTRIAL APPLICABILITY

The current invention is novel, useful and non-obvious and can be utilized in the industrial application of but not limited to: information technology, art and entertainment content creation and distribution, counter-intelligence and national security, copyright management, privacy protection, forensic analysis and law enforcement. Although the current invention can be used to remove watermark or other types of steganography messages from media contents, it can be used in any field where slight disruption of data does not impact the main usage of data significantly, but would disrupt a secondary usage of data. For example it can be used in gene modification in the biology field. Specifically, segments of artificially inserted genes may carry no expressed functionality except for identifying the origin of the gene. Such gene segments can be scrambled using methods according to current claims to remove such identifying information from the gene. A biological organism developed from such a modified gene will grow up just the same, as the scrambled part of the gene is never expressed, however the hidden information embedded in the scrambled section of gene is no longer traceable as its sequence is scrambled.

The inventor claims:

1. A method of processing input audio content to create output audio content, comprising:
1A. provided such input audio may contain hidden information sequentially embedded;
1B. providing input audio comprising analog or digital data laid out in a time sequence;
1C. obtaining from input audio small slices of audio each of very short time duration;
1D. sequence of the slices of audio data is scrambled, with some slices removed, replicated, swapped, moved, averaged, or otherwise altered;
1E. resulting audio slices are smoothly joined to construct a new audio content;
1F. new audio content is stored in a storage medium, or delivered to a receiver.

2. A method of processing input audio content according to claim 1, wherein slices of audio content are obtained from input audio by simple cutting and partitioning.

3. A method of processing input audio content according to claim 1, wherein slices of audio content are obtained by copying from sequentially moved positions in the input audio content.

4. A method of processing input audio content according to claim 1, wherein characteristics parameters are calculated for each slices of audio contents, and such parameters are used to construct new slices of audio to be scrambled and used to construct new audio content.

5. A method of processing input audio content according to claim 1, wherein two audio slices are smoothly joined by calculating a weighed average of sample data from the first slice and the second slice, with the weight for first slice is gradually reduced and the weight for the second slice is gradually increased accordingly.

6. An apparatus of embodiment using the method according to claim 1.

7. An apparatus that stores audio content created using the method according to claim 1.

8. A method of obtaining input audio content according to method in claim 1, wherein a source audio is obtained from recording or from storage medium, and is processed to obtain input audio in suitable format for processing by method according to claim 1.

9. A method of processing output audio created by method according to claim 1, wherein the output audio content is converted to audio content in suitable formats for useful purposes.

10. A method according to claim 1, wherein visual content is processed instead of audio.

11. An apparatus of embodiment using the method according to claim 10.

12. An apparatus that stores visual content created using the method according to claim 10.
